(19) United States
(12) Patent Application Publication
(10) Pub. No.: US 2026/0159397 A1
(43) Pub. Date: Jun. 11, 2026

(54) REDUCED GRAPHENE OXIDE-CONTAINING MATERIALS AND PREPARATION METHODS THEREOF

(71) Applicant: Khalifa University of Science and Technology, Abu Dhabi (AE)

(72) Inventors: Saeed ALHASSAN, Abu Dhabi (AE); Mariam ALI ALMAHR, Abu Dhabi (AE); Fouad Hassan ZOGHIEB, Abu Dhabi (AE)

(21) Appl. No.: 19/181,252

(22) Filed: Apr. 16, 2025

Related U.S. Application Data
(60) Provisional application No. 63/637,063, filed on Apr. 22, 2024.

(51) Int. Cl. C01B 32/198

(52) U.S. Cl. CPC C01B 32/198; C01P 2002/72; C01P 2002/82; C01P 2002/84; C01P 2002/85; C01P 2002/88; C01P 2004/03; C01P 2004/04; C01P 2006/16; C01P 2006/60

(57) ABSTRACT

A reduced graphene oxide-containing material includes a matrix material including a layered silicate, and reduced graphene oxide. A method for forming a reduced graphene oxide-containing material includes mixing graphene oxide, a layered silicate, and a solvent to form a mixture; at least partially removing the solvent from the mixture to form a first material; and thermally treating the first material to at least partially reduce the graphene oxide and sufficient to form a second material including reduced graphene oxide.

### CROSS-REFERENCE TO RELATED APPLICATIONS

This application claims the benefit of and priority to U.S. provisional application 63/637,063, titled “TRANSPARENT COMPOSITES USING REDUCED GRAPHENE OXIDE”, filed Apr. 22, 2024, the contents of which are incorporated by reference herein.

### TECHNICAL FIELD

The subject matter disclosed herein relates to films and composites, and more particularly to reduced graphene oxide-containing materials. The present invention further relates to methods for manufacturing such films and composites.

### BACKGROUND

Graphene oxide (GO) and its reduced form (reduced graphene oxide “rGO”) have emerged as versatile nanomaterials with tunable properties, making them desirable for a wide range of applications in electronics, energy storage, and composite materials, due to unique structural and electronic characteristics. However, the optical properties are highly sensitive to the degree of oxidation and reduction, which significantly influences performance in various applications. Graphene oxide-based composites typically exhibit a dark appearance due to the presence of oxygen-containing functional groups, such as hydroxyl, epoxy, and carboxyl groups. These functional groups disrupt the sp² hybridized carbon structure of graphene, leading to an increased bandgap and greater optical absorption in the visible spectrum. The optical properties of graphene oxide can be modulated by partial reduction, which removes some oxygen functional groups, but only partially restores the sp²-conjugated network of the graphene. Conventionally, even after reduction, reduced graphene oxide retains residual oxygen groups and defects that prevent it from exhibiting a desirable optical transparency. Further, certain polymers have been added with graphene oxide to form composites and to enhance functionality. However, these composites present additional challenges in maintaining optical clarity due to phase separation and increased scattering caused by the polymers. Accordingly, efficiently forming reduced graphene oxide-containing materials exhibiting desirable optical transparency and mechanical stability has remained a challenge.

### SUMMARY

According to one aspect, a reduced graphene oxide-containing material includes a matrix material including a layered silicate, and reduced graphene oxide.

According to another aspect, a method for forming a reduced graphene oxide-containing material includes mixing graphene oxide, a layered silicate, and a solvent to form a mixture; at least partially removing the solvent from the mixture to form a first material; and thermally treating the first material to at least partially reduce the graphene oxide and sufficient to form a second material including reduced graphene oxide.

According to another aspect, a method for forming a reduced graphene oxide-containing material includes mixing graphene oxide, a nanomaterial, and a solvent to form a mixture, wherein the nanomaterial is capable of forming a substantially homogeneous dispersion in water; freeze-drying the mixture to at least partially remove the solvent and to form a freeze-dried material; and treating the freeze-dried material to at least partially reduce the graphene oxide and sufficient to form a product material including reduced graphene oxide.

### BRIEF DESCRIPTION OF THE DRAWINGS

FIG. 1A illustrates a graphene oxide containing composition, according to some embodiments.

FIG. 1B illustrates a reduced graphene oxide-containing material, according to some embodiments.

FIG. 2 illustrates a method for forming a reduced graphene oxide-containing material, according to some embodiments.

FIG. 3 illustrates a method for forming a reduced graphene oxide-containing material, according to some embodiments.

FIG. 4A illustrates an example process for forming a reduced graphene oxide-containing material, according to some embodiments.

FIG. 4B illustrates L/GO films before thermal reduction, with varying amounts of graphene oxide added during the formation process, according to some embodiments.

FIG. 4C illustrates L/rGO films after thermal reduction, with varying amounts of graphene oxide added during the formation process, according to some embodiments.

FIG. 5A illustrates X-ray diffraction (XRD) analysis of an L/GO film before reduction, having varying amounts of graphene oxide added during the formation process, with the inset showing a normalized intensity, according to some embodiments.

FIG. 5B illustrates X-ray diffraction (XRD) analysis of an L/rGO film after reduction, having varying amounts of graphene oxide added during the formation process, with the inset showing a normalized intensity, according to some embodiments.

FIG. 6A illustrates Raman spectroscopy analysis of an L/GO film before reduction, having varying amounts of graphene oxide added during the formation process, with the inset showing an enlarged view from 2500 cm⁻¹ to 2800 cm⁻¹, according to some embodiments.

FIG. 6B illustrates Raman spectroscopy analysis of an L/rGO film after reduction, having varying amounts of graphene oxide added during the formation process, according to some embodiments.

FIG. 7 illustrates ultraviolet-visible (UV-vis) spectroscopy of L/GO and L/rGO, both formed using a graphene oxide weight percentage of 8 wt. % relative to the total weight of layered silicate, according to some embodiments.

FIG. 8A illustrates X-ray photoelectron spectroscopy (XPS) analysis in the C1s before thermal treatment of an L/GO film, according to some embodiments.

FIG. 8B illustrates X-ray photoelectron spectroscopy (XPS) analysis in the C1s after thermal treatment of an L/rGO film, according to some embodiments.

FIG. 9A illustrates a scanning electron microscope (SEM) cross-section image of L/GO film before thermal treatment, according to some embodiments.

FIG. 9B illustrates a scanning electron microscope (SEM) cross-section image of L/GO film before thermal treatment, according to some embodiments.

FIG. 9C illustrates a scanning electron microscope (SEM) cross-section image of L/GO film before thermal treatment, according to some embodiments.

FIG. 9D illustrates a scanning electron microscope (SEM) cross-section image of L/GO film before thermal treatment, according to some embodiments.

FIG. 10A illustrates a scanning electron microscope (SEM) cross-section image of L/rGO film after thermal treatment, according to some embodiments.

FIG. 10B illustrates a scanning electron microscope (SEM) cross-section image of L/rGO film after thermal treatment, according to some embodiments.

FIG. 10C illustrates a scanning electron microscope (SEM) cross-section image of L/rGO film after thermal treatment, according to some embodiments.

FIG. 10D illustrates a scanning electron microscope (SEM) cross-section image of L/rGO film after thermal treatment, according to some embodiments.

FIG. 11A illustrates atomic force microscopy (AFM) phase imaging of L/GO film before thermal treatment, according to some embodiments.

FIG. 11B illustrates atomic force microscopy (AFM) phase imaging results of L/GO film before thermal treatment, according to some embodiments.

FIG. 11C illustrates atomic force microscopy (AFM) phase imaging of L/GO film before thermal treatment, according to some embodiments.

FIG. 12A illustrates atomic force microscopy (AFM) phase imaging of L/rGO film after thermal treatment, according to some embodiments.

FIG. 12B illustrates atomic force microscopy (AFM) phase imaging results of L/rGO film after thermal treatment, according to some embodiments.

FIG. 12C illustrates atomic force microscopy (AFM) phase imaging of L/rGO film after thermal treatment, according to some embodiments.

FIG. 13 illustrates composites of the present disclosure before and after thermal treatment, using different concentrations of graphene oxide relative to layered silicate during the formation process, according to some embodiments.

FIG. 14A illustrates a Raman spectrum of an L/GO composite before thermal treatment, according to some embodiments.

FIG. 14B illustrates a Raman spectrum of an L/GO composite before thermal treatment, according to some embodiments.

FIG. 14C illustrates a Raman spectrum of an L/rGO composite after thermal treatment, according to some embodiments.

FIG. 14D illustrates a Raman spectrum of an L/rGO composite after thermal treatment, according to some embodiments.

FIG. 15 illustrates thermogravimetric analysis (TGA) of the L/GO composite, L/rGO composites of the present disclosure, pure graphene oxide (GO), and pure layered silicate (L), according to some embodiments.

### DETAILED DESCRIPTION

Embodiments of the present disclosure provide reduced graphene oxide-containing materials and methods for forming reduced graphene oxide-containing materials. The materials and methods are utilized for forming reduced graphene oxide-containing materials exhibiting excellent optical transparency and mechanical stability. These formulations utilize graphene oxide and a layered silicate for producing materials exhibiting excellent light transmittance, where the layered silicate reduces and/or prevents aggregation and restacking of graphene oxide before and/or during the reduction process. Since these materials exhibit excellent optical transparency (compared to conventional reduced graphene oxide having low light transmittance), these materials can be used in a wide range of applications, such as optical devices, transparent conductive films, flexible electronics, thermal management systems, and additional applications harnessing substantially transparent materials.

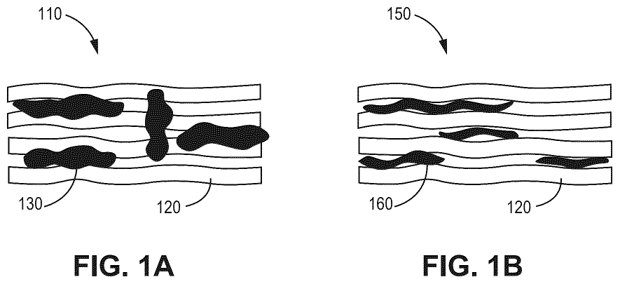

FIG. 1A illustrates a graphene oxide containing composition, according to some embodiments. Graphene oxide containing composition 110 includes graphene oxide 130 and layered silicate 120. In one example, graphene oxide containing composition 110 is in the form of a dispersion with water. In another example, graphene oxide containing composition 110 is substantially free of a dispersing liquid. Graphene oxide containing composition 110 can be formed as an intermediate for forming reduced graphene-oxide containing materials of the present disclosure. FIG. 1B illustrates a reduced graphene oxide-containing material, according to some embodiments. Reduced graphene oxide-containing material 150 includes layered silicate 120 and reduced graphene oxide 160. Reduced graphene oxide-containing material 150 can be formed using treatment (e.g., thermal treatment) of graphene oxide containing composition 110. Reduced graphene oxide 160 and layered silicate 120 are shown in FIG. 1B for illustrative purposes, and dimensions, shapes, amounts, and/or orientations of reduced graphene oxide 160 and/or layered silicate 120 can be tuned according to desirable properties. As shown, reduced graphene oxide 160 can be at least partially intercalated between layers of layered silicate 120.

Embodiments of the present disclosure include reduced graphene oxide 160, such as reduced graphene oxide nanosheets. Reduced graphene oxide 160 is formed by at least partially reducing graphene oxide 130. Reducing graphene oxide 130 includes removing one or more oxygen-containing functional groups from graphene oxide 130. Reduction can be performed using chemical reduction, electrochemical reduction, and/or thermal reduction. Reduced graphene oxide 160 can be substantially similar to graphene. Reduced graphene oxide 160 can include at least 80 wt. % carbon based on elemental analysis. Reduced graphene oxide 160 can include at least 90 wt. % carbon based on elemental analysis.

Reduced graphene oxide 160 includes less oxygen-containing groups compared to graphene oxide 130. In one example, reduced graphene oxide 160 can still include some residual oxygen-containing groups, even after reduction. For example, reduced graphene oxide 160 can include less than 15 wt. % oxygen based on elemental analysis. In another example, reduced graphene oxide 160 includes less than 10 wt. % oxygen based on elemental analysis. In another example, reduced graphene oxide 160 includes less than 5 wt. % oxygen based on elemental analysis. Reduced graphene oxide 160 exhibits higher electrical and thermal conductivity compared to graphene oxide 130 due to the reduction of oxygen groups.

Graphene oxide 130 is a carbon-based nanomaterial and is the oxidized form of graphene. Graphene oxide 130 can be formed by the oxidation of graphite. Accordingly, graphene oxide 130 is functionalized, and graphene oxide 130 can include oxygen-containing functional groups and aromatic domains. Conventional graphene oxide-based materials typically exhibit a dark appearance due to the presence of oxygen-containing functional groups, such as hydroxyl, epoxy, and carboxyl groups. These functional groups in conventional graphene-oxide based materials disrupt the sp² hybridized carbon structure of graphene, leading to an increased bandgap and greater optical absorption in the visible spectrum.

Graphene oxide 130 can be synthesized using Hummers' method. Hummers' method can include a chemical process to produce graphene oxide 130, such as using at least one of sulfuric acid, sodium nitrate, and potassium permanganate. In one example, sulfuric acid can be cooled, and graphite flakes and sodium nitrate can be added to the cooled sulfuric acid to form a solution. After, potassium permanganate can be added to the solution. The solution can be stirred and transferred to an ice bath. After, deionized water can be added, and the solution can be stirred at room temperature. Then, deionized water can be added to the solution followed by the dropwise addition of hydrogen peroxide. The solution can be vacuum filtered and washed, and the recovered graphite oxide cake may be washed with hydrochloric acid solution and vacuum filtered again. The mud can then be washed with deionized water until the pH rises. Finally, the graphite oxide may be diluted with deionized water and exfoliated with an ultrasonicator to produce graphene oxide nanosheets.

Reduced graphene oxide-containing materials 150 of the present disclosure include one or more silicates. Silicates include silicon and oxygen, and silicates of the present disclosure can include naturally formed silicates and synthetic silicates. The silicates of the present disclosure generally exhibit a layered structure. Accordingly, these silicates of the present disclosure are referred to as layered silicates 120. Layered silicates include one or more sheets including silicon atoms and oxygen atoms. Layered silicates 120 can include a layered structure formed by sheets of silicate tetrahedra. Layered silicates 120 can swell in water to give clear, colloidal dispersions. Further, highly thixotropic gels can be produced. These layered silicates can include layered silicates capable of being a substantially (optically) transparent matrix material for graphene oxide.

The layered silicate 120 can include a smectite material. Smectite materials include naturally formed smectite-containing materials and/or synthetic smectite-containing materials. Smectite materials exhibit a 2-1 layered structure. A 2-1 layered structure includes an octahedral sheet between two tetrahedral sheets. 2-1 layered structures of the present disclosure can include a trioctahedral 2-1 layered structure or a dioctahedral 2-1 layered structure. Even after reduction of graphene oxide, the layered silicate 120 can substantially maintain structural integrity.

In one example, the smectite material includes Laponite®. Laponite® is a synthetic layered silicate that generally follows the chemical formula: Na^{+0.7}[(Si₈Mg_{5.5}Li_{0.3})O₂₀(OH)₄]^{-0.7}. In one non-limiting example, Laponite® can include about 59.5 wt. % SiO₂, about 27.5 wt. % MgO, about 2.8 wt. % Na₂O, and about 0.8 wt. % Li₂O. Laponite® exhibits excellent optical transparency, thermal stability, and ability to form stable colloidal dispersions. In another example, the smectite includes hectorite. Hectorite is a smectite mineral. Layers of hectorite can include two Si—O—Si tetrahedral sheets sandwiching a Mg—O—Li octahedral sheet in a 2-1 arrangement. Hectorite can follow the formula: Na_{0.3}(Mg,Li)₃Si₄O₁₀(F,OH)₂·nH₂O, where n can be 0 or 1 or greater. Hectorite can follow the formula: Na_{0.4}Mg_{2.7}Li_{0.3}Si₄O₁₀(OH)₂.

In one example, the smectite material can include montmorillonite, saponite, and/or fluorohectorite. These layered silicates can exhibit a similar 2:1 sheet structure and can be exfoliated in aqueous environments to form colloidal dispersions. In one non-limiting example, while these layered silicates may not offer the same degree of optical clarity as Laponite®, some—such as fluorohectorite—can still support the formation of transparent or white graphene-based composites. In another example, these can be desirable for bulk composites or applications where transparency is not the primary desired property, such as thermal insulation, structural fillers, or conductive pastes. These additional layered silicates can support the dispersion of GO/rGO and contribute to the porosity, mechanical strength, and/or thermal stability of the product, while still preserving the layered silicate nature of the matrix.

The smectite material can be in the form of nanomaterial. In one example, the smectite material includes a plurality of nanoplatelets and/or nanosheets. Nanoplatelets can be in a stacked orientation, and upon the introduction to water, can be dispersed within water to form an aqueous dispersion. The nanomaterial can exhibit an average width of about 20 nm to about 50 nm, and the nanomaterial can exhibit an average height of about 0.5 nm to about 3 nm. The nanomaterial can exhibit an average width of about 25 nm to about 40 nm, and the nanomaterial can exhibit an average height of about 0.5 nm to about 1.5 nm.

A weight percentage of the layered silicate 120 in the reduced graphene oxide-containing material 150 can be greater than 60 wt. %. In one example, the weight percentage of the layered silicate 120 in the reduced graphene oxide-containing material 150 is greater than 70 wt. %. In another example, the weight percentage of the layered silicate 120 in the reduced graphene oxide-containing material 150 is greater than 80 wt. %. In another example, the weight percentage of the layered silicate 120 in the reduced graphene oxide-containing material 150 is greater than 90 wt. %.

In one example, compared to reducing a single-layer of graphene oxide to form a single-layer of reduced graphene oxide, materials of the present disclosure include multiple reduced graphene oxide 160 sheets, improving scalability. The layered silicate 120 can promote stabilization of the graphene oxide 130 before or during reduction, reducing or preventing aggregation and restacking of graphene oxide 130 sheets during reduction, such as thermal reduction. Upon addition of graphene oxide 130 during the formation process, graphene oxide 130 sheets can at least partially intercalate into layers of the layered silicate 120. Intercalation can include at least partial introduction of the graphene oxide 130 sheets into interlayer spaces of the layered silicate 120. In one example, interactions between the layered silicate 120 and the graphene oxide 130 (or reduced graphene oxide 160) include non-covalent interactions and/or electrostatic interactions. The layered silicate 120 can also reduce or prevent restacking of reduced graphene oxide 160 after the reduction process. Since restacking of graphene oxide 130 or reduced graphene oxide 160 reduces optical transparency, the layered silicate 120 reduces or prevents this restacking to promote desirable optical transparency.

The enhanced structure including reduced graphene oxide 160 and layered silicate 120 promotes improved electrical and mechanical properties of the reduced graphene oxide-containing material 150. Further, the reduced graphene oxide-containing materials 150 of the present disclosure exhibit even greater thermal stability due to strong interfacial interactions between the reduced graphene oxide 160 and the layered silicate 120, compared to a pure layered silicate. The reduced graphene oxide-containing material 150 can be in the form of a film or composite. The composite can be subsequently refined to form reduced graphene oxide-containing particles.

The weight percentage of reduced graphene oxide 160 to the total weight of layered silicate 120 in the reduced graphene oxide-containing material 150 can be tuned to promote desirable optical transparency and mechanical stability. The weight percentage of the reduced graphene oxide 160 can be greater than 0.01 wt. %, greater than 0.1 wt. %, greater than 1 wt. %, or values therebetween, based on a total weight of the layered silicate 120 in the reduced graphene oxide-containing material 150. The weight percentage of the reduced graphene oxide 160 can be less than 25 wt. %, based on a total weight of the layered silicate 120 in the reduced graphene oxide-containing material 150. In one example, the weight percentage of the reduced graphene oxide 160 is less than 15 wt. %, based on a total weight of the layered silicate 120 in the reduced graphene oxide-containing material 150.

The weight percentage of the reduced graphene oxide 160 can be less than 8 wt. %, based on a total weight of the layered silicate 120 in the reduced graphene oxide-containing material 150. For example, utilizing a weight percentage of the reduced graphene oxide 160 of less than 8 wt. %, based on a total weight of the layered silicate 120 in the reduced graphene oxide-containing material 150, can promote desirable optical transparency and mechanical stability. In another example, the weight percentage of the reduced graphene oxide 160 is less than 12 wt. %, less than 11 wt. %, less than 10 wt. %, less than 8 wt. %, less than 6 wt. %, less than 5 wt. %, less than 4 wt. %, or values therebetween, based on a total weight of the layered silicate 120 in the reduced graphene oxide-containing material 150.

A weight percentage of the reduced graphene oxide 160 can range from 0.01 wt. % to 15 wt. % of a total weight of the layered silicate 120 in the reduced graphene oxide-containing material 150. In one example, the weight percentage of the reduced graphene oxide 160 can range from 0.01 wt. % to 10 wt. % of a total weight of the layered silicate 120 in the reduced graphene oxide-containing material 150. In another example, the weight percentage of the reduced graphene oxide 160 can range from 0.01 wt. % to 8 wt. % of a total weight of the layered silicate 120 in the reduced graphene oxide-containing material 150. In another example, the weight percentage of the reduced graphene oxide 160 can range from 1 wt. % to 8 wt. % of a total weight of the layered silicate 120 in the reduced graphene oxide-containing material 150.

The reduced graphene oxide-containing material 150 exhibits excellent light transmittance in the visible light spectrum. The reduced graphene oxide-containing material 150 can exhibit an average light transmittance value of greater than 70% at wavelengths greater than 300 nm. In one example, the reduced graphene oxide-containing material 150 can exhibit an average light transmittance value of greater than 70%, or greater than 80%, at wavelengths ranging from 400 nm to 1200 nm. The reduced graphene oxide-containing material 150 can exhibit an average light transmittance value of greater than 70% at a wavelength of 550 nm. In one example, the reduced graphene oxide-containing material 150 can exhibit an average light transmittance value of greater than 75% at a wavelength of 550 nm. In another example, the reduced graphene oxide-containing material 150 can exhibit an average light transmittance value of greater than 80% at a wavelength of 550 nm. Light transmittance can be measured using ultraviolet-visible (UV-vis) spectroscopy.

The reduced graphene oxide-containing material 150 can exhibit an average pore size of greater than about 1.3 nm. In one example, the reduced graphene oxide-containing material 150 exhibits an average pore size greater than about 1.5 nm. In another example, the reduced graphene oxide-containing material 150 exhibits an average pore size greater than about 1.7 nm. The reduced graphene oxide-containing material 150 can exhibit an average pore volume of less than 0.15 cm³/g. In one example, the reduced graphene oxide-containing material 150 exhibits an average pore volume of less than 0.1 cm³/g. The average pore size and average pore volume can be determined using Brunauer-Emmett-Teller (BET) analysis. In one example, the reduced graphene oxide-containing material 150 exhibits a BET surface area of greater than 100 m²/g. In another example, the reduced graphene oxide-containing material 150 exhibits a BET surface area of less than 300 m²/g. The BET surface area can be determined using Brunauer-Emmett-Teller (BET) analysis.

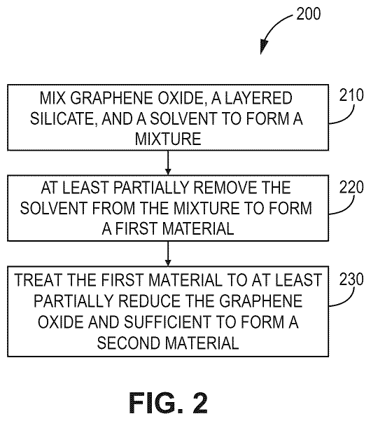

FIG. 2 illustrates method 200 for forming a reduced graphene oxide-containing material, according to some embodiments. Method 200 can form reduced graphene oxide-containing materials of the present disclosure, such as reduced graphene oxide-containing material 150.

Graphene oxide, a layered silicate, and a solvent are mixed 210 to form a mixture. Mixing 210 can include contacting, stirring, heating, and/or placing in close physical proximity. The mixture can be in the form of a dispersion. The graphene oxide, layered silicate, and solvent can be mixed simultaneously or in various orders. In one example, the layered silicate is mixed with the solvent; then graphene oxide is added. For example, the layered silicate can be dispersed (e.g., substantially homogeneously dispersed) in the solvent to form a dispersion prior to addition of the graphene oxide. After forming the dispersion, graphene oxide can be added to the dispersion. The layered silicate includes one or more layered silicates of the present disclosure, such as layered silicate 120. The graphene oxide includes graphene oxide of the present disclosure, such as graphene oxide 130. Importantly, the graphene oxide can be at least partially incorporated into the layered silicate matrix, promoting an enhanced distribution of graphene oxide sheets, reducing aggregation and enabling enhanced interactions between the layered silicate and graphene oxide.

The amount of the layered silicate with respect to volume of the solvent can be tuned to promote desirable dispersion and concentrations of the layered silicate in the formed product material. In one example, 0.05 g to 1 g of the layered silicate can be added to 10 mL of the solvent. In another example, 0.1 g to 1 g of the layered silicate is added to 10 mL of the solvent. In another example, 0.1 g to 0.5 g of the layered silicate is added to 10 mL of the solvent. In another example, about 0.3 g of the layered silicate is added to 10 mL of the solvent. For purposes herein, the dispersion including the layered silicate and solvent, prior to graphene oxide addition, can be referred to as the first dispersion.

Graphene oxide can be separately mixed with a solvent and added to the first dispersion. The amount of graphene oxide with respect to volume of the solvent can be tuned to promote desirable dispersion and concentrations of graphene oxide in the formed product material. In one example, graphene oxide is mixed with a solvent to form a dispersion having a concentration of graphene oxide ranging from 1 mg/mL to 300 mg/mL. In another example, graphene oxide is mixed with a solvent to form a dispersion having a concentration of graphene oxide ranging from 10 mg/mL to 100 mg/mL. In another example, graphene oxide is mixed with a solvent to form a dispersion having a concentration of graphene oxide ranging from 30 mg/mL to 60 mg/mL. Sonication can be utilized for a period of time (e.g., 10 minutes to 3 hours) sufficient to substantially homogeneously disperse the graphene oxide in the solvent. For purposes herein, the mixture of graphene oxide and a solvent can be referred to as a second dispersion.

The second dispersion can be added to the first dispersion to form the mixture, and the second dispersion and first dispersion can be mixed for a period of time for substantially homogeneous mixing. A weight percentage of graphene oxide in the mixture can be greater about 0.01 wt. % of a total weight of the layered silicate in the mixture. In one example, the weight percentage of graphene oxide in the mixture can be greater about 0.5 wt. % of a total weight of the layered silicate in the mixture. In another example, the weight percentage of graphene oxide in the mixture can be greater about 1 wt. % of a total weight of the layered silicate in the mixture. A weight percentage of graphene oxide in the mixture can be less than about 25 wt. % of a total weight of the layered silicate in the mixture. The weight percentage of graphene oxide in the mixture can be less than about 15 wt. % of a total weight of the layered silicate in the mixture. The weight percentage of graphene oxide in the mixture can be less than about 10 wt. % of a total weight of the layered silicate in the mixture. In one non-limiting example, utilizing a weight percentage of graphene oxide in the mixture of less than about 10 wt. % of the total weight of the layered silicate in the mixture can promote desirable optical transparency (e.g., average light transmittance value of greater than 70% at wavelengths ranging from 400 nm to 1200 nm) and mechanical stability to the product material.

A weight percentage of graphene oxide in the mixture can range from 0.01 wt. % to 25 wt. % of a total weight of the layered silicate in the mixture. In one example, the weight percentage of graphene oxide in the mixture ranges from 0.01 wt. % to 15 wt. % of a total weight of the layered silicate in the mixture. In another example, the weight percentage of graphene oxide in the mixture ranges from 0.05 wt. % to 10 wt. % of a total weight of the layered silicate in the mixture. In one non-limiting example, utilizing a weight percentage of graphene oxide in the mixture ranging from 0.05 wt. % to 10 wt. % of the total weight of the layered silicate in the mixture can promote desirable optical transparency (e.g., average light transmittance value of greater than 70% at wavelengths ranging from 400 nm to 1200 nm) and mechanical stability to the product material. In another example, the weight percentage of graphene oxide in the mixture ranges from 1 wt. % to 8 wt. % of a total weight of the layered silicate in the mixture.

The solvent can include at least one of: water, an alcohol, an organic solvent, an alkane, and an aromatic solvent. Examples of alcohol solvents include methanol and ethanol. Examples of organic solvents include ethyl acetate, N,N-Dimethylformamide (DMF), and Dimethyl sulfoxide (DMSO). Examples of alkanes include pentane and hexane. Examples of aromatic solvents include benzene and toluene. In one non-limiting example, the solvent includes at least one of water, N,N-Dimethylformamide (DMF), and Dimethyl sulfoxide (DMSO). In another non-limiting example, the solvent is deionized water.

The solvent is at least partially removed 220 from the mixture to form a first material. The first material can include graphene oxide and the layered silicate, but can be substantially free of solvent. At least partially removing 220 the solvent generally includes performing at least one of evaporation or lyophilization. Evaporation can include open evaporation or the use of heat, rotation, and/or vacuum to promote evaporation of the solvent. Open evaporation includes allowing the solvent to evaporate at ambient conditions (e.g., about 22° C. and 1.01 bar). Open evaporation can be performed for 1 or more hours, such as 6 or more hours. Prior to, or simultaneously with, at least partially removing 220 the solvent, the mixture can be spread (e.g., cast) on a surface. The mixture can be spread on the surface, and the solvent is at least partially removed 220 from the mixture to form a first material. Accordingly, the first material can be formed as a film.

The mixture can be subjected to lyophilization. Lyophilization includes at least partially removing the solvent (e.g., water) by utilizing low temperatures and using a vacuum. Lyophilization can be used to promote water sublimation. In one example, lyophilization includes cooling the mixture at a temperature of less than −20° C. In another example, lyophilization includes cooling the mixture at a temperature of less than −60° C. Simultaneously, or after cooling, the mixture can be placed under vacuum sufficient for sublimation. Lyophilization can form a first material in the form of a composite.

The first material is treated 230 to at least partially reduce the graphene oxide and sufficient to form a second material. Treating 230 is sufficient to at least partially reduce graphene oxide in the first material-forming a second material including reduced graphene oxide, such as reduced graphene oxide 160. The second material generally also includes the layered silicate. Treating 230 can remove oxygen functionalities such as hydroxyl, epoxy, carbonyl, and carboxyl groups. Treating 230 can include at least one of: thermal treatment and chemical photoreduction. In one example, treating 230 includes using an inert gas. Thermal treatment can include heating the first material at/to a temperature of greater than 300° C. In one example, thermal treatment includes heating the first material at/to a temperature of greater than 400° C. In one example, thermal treatment includes heating the first material at/to a temperature of greater than 450° C.

Thermal treatment can be performed for a period of time, such as at least 30 minutes, at least 1 hour, or at least 2 hours. The inert gas can include at least one of argon, helium, and nitrogen. Thermal treatment can promote greater control over the reduction conditions, resulting in improved interfacial bonding and tailored properties of reduced graphene oxide within the second material. In one non-limiting example, and for comparison, compared to incorporating pre-reduced graphene oxide to form the first material, thermal reduction allows for enhanced graphene oxide dispersion and enhanced matrix interaction, simplifying processing while promoting uniformity.

The first material can be subjected to chemical photoreduction. Chemical photoreduction can include exposing the first material to radiation sufficient to at least partially reduce the graphene oxide in the first material. The first material is exposed to radiation at an intensity and wavelength capable of reducing graphene oxide. In one example, the radiation includes ultraviolet radiation. For example, the radiation can include UV-A radiation having a wavelength of between about 315 nm and about 400 nm. The first material can be exposed to radiation for longer than 1 minute, longer than 10 minutes, longer than 1 hour, or longer than 3 hours.

Method 200 forms a reduced graphene oxide-containing material of the present disclosure. Integration of the graphene oxide into the layered silicate matrix promotes a well-dispersed system, enhancing optical transparency while maintaining desirable mechanical integrity. The graphene oxide can at least partially intercalate into the layered silicate layers, reducing the interlayer spacing and replacing water. Additionally, the graphene oxide interlayer spacing can be decreased, where cationic sites and layered silicate surfaces can alter the stacking of graphene oxide sheets. This combination can promote a formed reduced graphene oxide-containing material exhibiting a distinct interlayer arrangement. Before reduction, the layered silicate can prevent excessive stacking of graphene oxide sheets and can maintain a partially exfoliated structure despite the presence of oxygenated groups. After reduction, the layered silicate can minimize restacking of reduced graphene oxide, without the layered silicate undergoing significant structural changes.

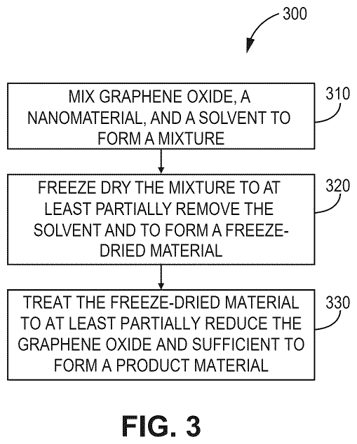

FIG. 3 illustrates method 300 for forming a reduced graphene oxide-containing material, according to some embodiments. Method 300 can form reduced graphene oxide-containing materials of the present disclosure.

Graphene oxide, a nanomaterial, and a solvent are mixed 310 to form a mixture. Mixing 310 can include contacting, stirring, heating, and/or placing in close physical proximity. The mixture can be in the form of a dispersion. Graphene oxide can include graphene oxide of the present disclosure, such as a plurality of graphene oxide sheets. The nanomaterial includes a nanomaterial capable of being dispersed in water. For example, the nanomaterial can include a dispersible nanoparticle. The nanomaterial can form a substantially homogeneous dispersion in water. Alternatively, or additionally, the nanomaterial can include a layered silicate of the present disclosure.

The nanomaterial generally enables the formation of a substantially stable, porous 3D architecture after freeze-drying with graphene oxide (GO) or reduced graphene oxide (rGO). The nanomaterial can be a structural stabilizer, spacer, or scaffold that substantially prevents graphene oxide restacking, promotes porosity, and maintains integrity during sublimation and/or thermal processing. The nanomaterial can include platelet-shaped, lamellar, and/or fibrous material(s). In one example, it can be desirable to utilize a nanomaterial dispersible or colloidally stable in aqueous or polar media. In another example, it can be desirable to utilize a nanomaterial that is thermally and chemically stable to withstand reduction steps. In one example, the nanomaterial exhibits a lateral dimension ranging from 50 nm to 5 μm and a thickness of less than 100 nm. These dimensions can promote uniform dispersion, effective interaction with graphene oxide, and structural retention upon freeze-drying.

In one example, the nanomaterial includes 2D sheet-like material. For example, the 2D sheet-like material can include a layered silicate. The layered silicate can include a layered silicate of the present disclosure. In one example, the layered silicate includes an exfoliated smectite, such as montmorillonite and/or fluorohectorite. These materials can provide sufficient light scattering and structural integrity to yield visibly white composites even after reduction. In another example, the nanomaterial includes a fibrous material, such as cellulose nanofibers. These materials can be characterized by their high surface area, nanometric dimensions, and low intrinsic optical absorption, enabling the formation of light-colored or white bulk structures desirable for applications such as optics, coatings, and thermal insulation. In one non-limiting example, and in contrast, nanomaterials such as MXenes, carbon black, or metal nanoparticles can form dark-colored composites, which may have undesirable optical characteristics.

The graphene oxide, nanomaterial, and solvent can be mixed simultaneously or in various orders. In one example, the nanomaterial is mixed with the solvent; then graphene oxide is added. For example, the nanomaterial can be dispersed (e.g., substantially homogeneously dispersed) in the solvent to form a dispersion prior to addition of the graphene oxide. After forming the dispersion, graphene oxide can be added to the dispersion. Graphene oxide can be mixed with a solvent of the present disclosure prior to addition.

A weight percentage of graphene oxide in the mixture can be greater about 0.01 wt. % of a total weight of the nanomaterial in the mixture. In one example, the weight percentage of graphene oxide in the mixture can be greater about 0.5 wt. % of a total weight of the nanomaterial in the mixture. In another example, the weight percentage of graphene oxide in the mixture can be greater about 1 wt. % of a total weight of the nanomaterial in the mixture. A weight percentage of graphene oxide in the mixture can be less than about 20 wt. % of a total weight of the nanomaterial in the mixture. The weight percentage of graphene oxide in the mixture can be less than about 10 wt. % of a total weight of the nanomaterial in the mixture.

A weight percentage of graphene oxide in the mixture can range from 0.01 wt. % to 25 wt. % of a total weight of the nanomaterial in the mixture. In one example, the weight percentage of graphene oxide in the mixture ranges from 0.01 wt. % to 15 wt. % of a total weight of the nanomaterial in the mixture. In another example, the weight percentage of graphene oxide in the mixture ranges from 0.01 wt. % to 8 wt. % of a total weight of the nanomaterial in the mixture. In another example, the weight percentage of graphene oxide in the mixture ranges from 1 wt. % to 8 wt. % of a total weight of the nanomaterial in the mixture.

The mixture is freeze-dried 320 to at least partially remove the solvent (e.g., solvent of the present disclosure) and to from a freeze-dried material. Freeze-drying 320 can include lyophilization. Lyophilization includes at least partially removing the solvent (e.g., water) by utilizing low temperatures and using a vacuum. Lyophilization can be used to promote water sublimation. In one example, lyophilization includes cooling the mixture at a temperature of less than −20° C. In another example, lyophilization includes cooling the mixture at a temperature of less than −60° C. Simultaneously, or after cooling, the mixture can be placed under vacuum sufficient for sublimation. Lyophilization can form a material in the form of a freeze-dried material (e.g., composite). In one example, performing freeze-drying 320 after mixing 310 can minimize or avoid restacking of graphene oxide.

The freeze-dried material is treated 330 to at least partially reduce the graphene oxide and sufficient to form a product material. Treating 330 can include one or more methods of treating 330. For example, treating 330 is sufficient to at least partially reduce graphene oxide in the freeze-dried material-forming a product material including reduced graphene oxide. Treating 330 can remove oxygen functionalities such as hydroxyl, epoxy, carbonyl, and carboxyl groups. Treating 330 can include at least one of thermal treatment and chemical photoreduction. Since performing freeze-drying 320 after mixing 310 can minimize or avoid restacking of graphene oxide, the product material exhibits excellent optical transparency. The product material can include reduced graphene oxide-containing materials of the present disclosure.

Methods 200 and 300 can efficiently form reduced graphene oxide-containing materials exhibiting excellent optical transparency and mechanical stability. In one non-limiting example, compared to a conventional process for reducing single-layer graphene oxide to form a single layer of reduced graphene oxide, methods of the present disclosure can be used to form films and composites including multiple layers of reduced graphene oxide. Therefore, these methods of the present disclosure promote efficient large-scale production of reduced graphene oxide-containing materials.

### Example 1—Formation Process

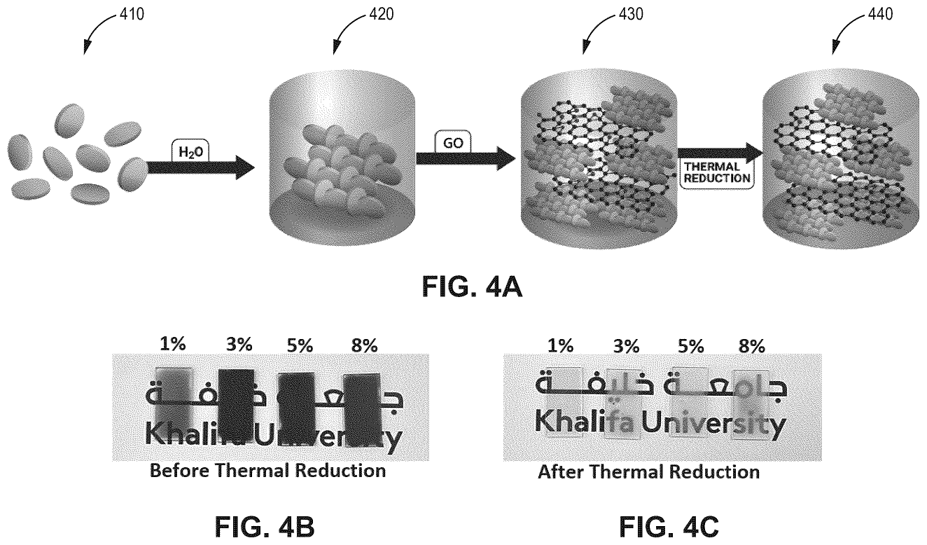

FIG. 4A illustrates an example process for forming a reduced graphene oxide-containing material, according to some embodiments. A layered silicate 410 is provided. In this example, the layered silicate is represented by the chemical formula: Na^{+0.7}[(Si₈Mg_{5.5}Li_{0.3})O₂₀(OH)₄]^{-0.7}. The layered silicate is mixed with water to form a dispersion 420. Graphene oxide is added to the dispersion 420 to form a mixture 430. The water can then be evaporated from the mixture. The mixture is thermally reduced 440 to form a graphene oxide-containing material.

### Example 2—Formation and Analysis

Graphene oxide is referred to herein as “GO”. Reduced graphene oxide is referred to herein as “rGO”. Layered silicate is referred to herein as “L”. The layered silicate used in the examples is Laponite®. The product material before reduction is referred herein to as “L/GO”. The product material after reduction is referred to herein as “L/rGO”. The layered silicate can remain chemically and structurally stable as a layered silicate even after thermal reduction. For example, this is shown by X-ray diffraction, thermogravimetric analysis indicating no structural decomposition, Raman spectroscopy showing the continued presence of the layered silicate-specific peak, and microscopy showing that the morphological role of layered silicate as a stabilizing scaffold is preserved.

Graphene oxide (GO) was synthesized using Hummers' method. A 3 wt. % layered silicate-containing dispersion was prepared by mixing 0.3 g of layered silicate in 10 mL of deionized (DI) water with continuous stirring to promote complete dispersion. Separately, a 40 mg/mL graphene oxide solution was prepared by dissolving graphene oxide powder in DI water, followed by 1 hour of sonication to form a homogeneous dispersion. For the mixtures, graphene oxide was added to the 3 wt % layered silicate dispersion at varying weight percentages: 3%, 5%, and 8%, relative to the total layered silicate content. To maintain a constant total volume, the amount of DI water was adjusted so that each dispersion had a final volume of 10 mL. The mixtures were stirred vigorously for 30 minutes to achieve uniform distribution of graphene oxide within the layered silicate matrix. The mixtures were used to form product materials-films and composites.

Films were prepared using the suspended casting method. Each composite mixture was poured onto 2 cm×2 cm clean glass substrates, with substantially even distribution across the surface. The films were left undisturbed to dry under ambient conditions (e.g., about 22° C. and 1.01 bar) for 24 hours, allowing the water to evaporate.

The composite was freeze-dried in its bulk form to remove water. The composite suspension was frozen at −80° C. and then lyophilized under vacuum to remove water while preserving the microstructure.

Once dried, the films and composites were thermally annealed at 500° C. in a nitrogen atmosphere for 2 hours to reduce the graphene oxide (to form reduced graphene oxide) and enhance the structural, mechanical, and optical properties. After annealing, the films were carefully peeled from the glass substrates and stored in sealed containers to prevent contamination and moisture absorption.

The structural, chemical, and morphological properties of the product films before and after thermal annealing were analyzed using a number of techniques. X-ray Diffraction (XRD) analysis was performed at 20 from 5° to 60°, using a Cu tube with Cu Kα source (λ=1.5406 Å). The Raman spectra of samples were measured using a Raman imaging instrument with 532 nm laser excitation. The laser spot size was maintained below 5 μm to achieve high spatial resolution and minimize interference from ambient molecules. Micro-Raman mapping experiments were conducted with a 125×125 pixel grid, with an integration time of 3 seconds per pixel, to evaluate the homogeneity and uniform distribution of graphene oxide and rGO within the layered silicate matrix.

X-ray photoelectron spectroscopy (XPS) measurements were performed on an XPS system. Survey scans were performed over a binding energy range from 0 to 1200 eV, with high-resolution scans focused on the C 1s and O 1s regions. Peak deconvolutions were performed using Shirley background subtraction and symmetrical Gaussian-Lorentzian mixture. The scanning electron microscope (SEM) images of all samples were acquired using a Nano SEM with an accelerating voltage of 5-10 kV and a working distance of about 10 mm. The atomic force microscopy (AFM) measurements were performed using an AFM microscope in tapping mode with a silicon probe of 10 nm tip radius to avoid damaging the surface. The scan area was set to 5 μm×5 μm, and the resulting height and phase images were analyzed to determine the surface roughness and ensure substantially uniform distribution of graphene oxide and rGO.

The optical properties were measured using a UV/Vis/NIR spectrometer. Absorption spectra data was recorded in the wavelength range of 200 nm to 1000 nm. The product materials were placed in the spectrometer's sample holder, and baseline correction was applied using a clean glass substrate. Optical absorption data was analyzed to monitor changes in transparency and confirm graphene oxide reduction by observing the shift in the absorption peak from the UV to visible region. The thermal properties were investigated by thermogravimetric analysis (TGA). The analysis was performed on a TGA system using a heating speed of 5° C./min from room temperature (e.g., about 22° C.) to 1000° C. under nitrogen atmosphere.

### Example 3—L/rGO Film

The formation of L/GO films was confirmed through a series of structural, optical, and thermal characterizations. The integration of graphene oxide into the layered silicate matrix resulted in a well-dispersed system, which played an important role in enhancing transparency while maintaining mechanical integrity. Thermal reduction under nitrogen further modified the material's structure, leading to observable changes in optical properties, as demonstrated through spectroscopic analysis.

FIG. 4B illustrates L/GO films before thermal reduction, with varying amounts of graphene oxide added during the formation process, according to some embodiments. FIG. 4C illustrates L/rGO films after thermal reduction, with varying amounts of graphene oxide added during the formation process, according to some embodiments. The transition from graphene oxide (GO) to reduced graphene oxide (rGO) in the nanocomposite film was visually evident from the optical appearance of the films after thermal treatment. Before thermal reduction, the film exhibited a dark, opaque appearance that intensifies with increasing graphene oxide concentration. After the thermal treatment, the same films appeared significantly more transparent.

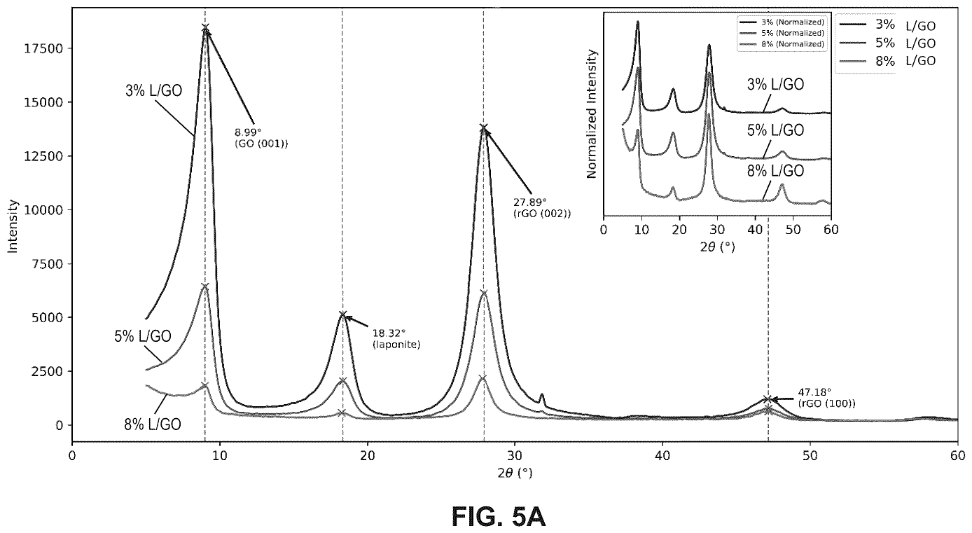

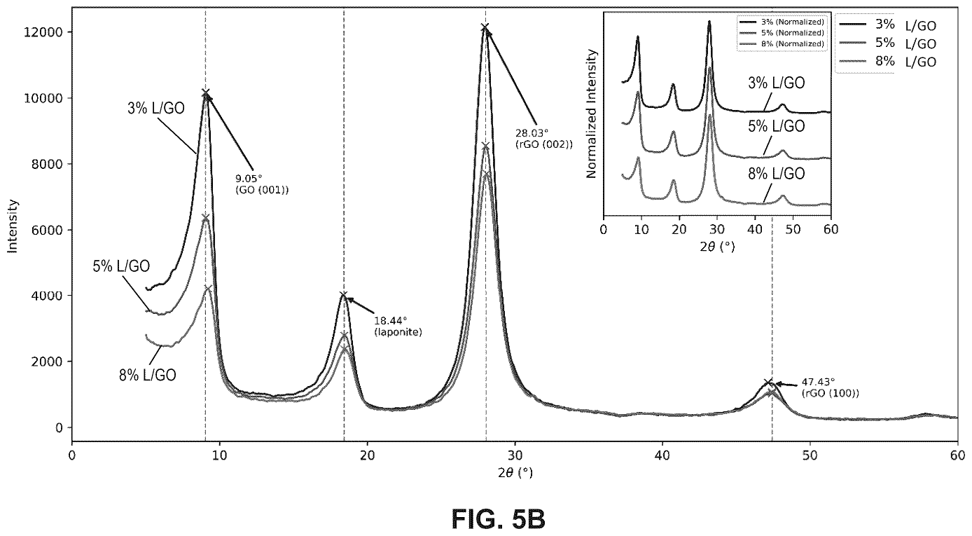

FIG. 5A illustrates X-ray diffraction (XRD) analysis of an L/GO film before reduction, having varying amounts of graphene oxide added during the formation process, with the inset showing a normalized intensity, according to some embodiments. FIG. 5B illustrates X-ray diffraction (XRD) analysis of an L/rGO film after reduction, having varying amounts of graphene oxide added during the formation process, with the inset showing a normalized intensity, according to some embodiments.

X-ray diffraction (XRD) analysis of L/GO films before and after thermal reduction reveals significant structural changes, confirming the successful thermal reduction of graphene oxide. An XRD pattern of graphite shows a prominent diffraction peak at 2θ=26.23°, corresponding to an interlayer spacing of about 3.34 Å. For graphene oxide, an XRD pattern differs significantly; the intensity of the peak at 2θ=26.23° decreases dramatically and broadens, while a new peak emerges at approximately 10.6°, with an interlayer spacing of about 8.35 Å, corresponding to the (001) plane of graphene oxide. This expanded interlayer spacing is attributed to the introduction of oxygenated functional groups within graphene oxide layers. In contrast, the pure layered silicate film exhibits two prominent peaks at 6.4° and 28.29° with interlayer spacing of 13.81 Å.

The XRD patterns of the L/GO films reveal a primary diffraction peak around 8.99° in the nanocomposite films prior to thermal treatment corresponding to interlayer spacing of 9.84 Å. This interlayer spacing lies between the values for pristine graphene oxide (8.35 A°) and pure layered silicate (13.81 A°), indicating significant structural reorganization. The reduction in the layered silicate interlayer spacing can show that graphene oxide sheets intercalated into the layered silicate layers, replacing water and forming a denser, hybrid structure. Concurrently, the increase in GO's interlayer spacing can show interactions with layered silicate, where cationic sites and layered silicate surfaces alter the stacking of graphene oxide sheets. This mutual interaction results in a material with a distinct interlayer arrangement.

A peak at 27.89° is observed, corresponding to the (002) plane of reduced graphene oxide (rGO). This peak signifies regions of graphitic ordering, which can be due to partial reduction of graphene oxide within the film and becomes sharper and more intense after thermal treatment. This sharpening indicates enhanced graphitic order as oxygenated groups in graphene oxide are reduced, allowing for more ordered stacking of the rGO layers. After thermal reduction, the XRD patterns of the L/GO films exhibit a shift of the primary diffraction peak to higher 20 value of 9.05°, corresponding to a decreased interlayer spacing of 9.77 Å. This change reflects the removal of oxygenated functional groups from graphene oxide and partial restoration of graphitic domains, leading to a more compact structure. The hybrid nature is maintained, but the thermal treatment further enhances the interactions between the layers, contributing to improved material properties.

Additionally, the rGO (100) peak, located at 47.11°-47.43° and corresponding to in-plane ordering of graphene sheets, also intensifies after thermal reduction, reflecting improved in-plane ordering of carbon atoms and increased graphitization. Throughout the thermal reduction process, the layered silicate nanoclay structure remains remarkably stable, as evidenced by the consistent peak observed at 18.32°-18.44° in all samples, before and after thermal treatment. This peak, representing the (001) plane of layered silicate, shows minimal changes in intensity and crystallite size, demonstrating that layered silicate retains its structural integrity under the reduction conditions. This stability demonstrates that layered silicate effectively supports the reduction process of graphene oxide to rGO without undergoing significant structural changes.

Moreover, as the graphene oxide concentration increases, the intensity of both the 27.89° (rGO (002)) and 8.99° peaks decreases, both before and after thermal treatment. This reduction in intensity suggests that higher graphene oxide content disrupts the structural order of the L/GO film, leading to a less organized structure. The additional graphene oxide may interfere with the regular stacking of layered silicate platelets, potentially increasing interlayer spacing, causing misalignment, or inducing an amorphous phase, which manifests as reduced XRD peak intensity. The emergence of more pronounced rGO (002) and (100) peaks, alongside the significant reduction of the graphene oxide (001) peak, shows the successful transformation of graphene oxide into rGO during the thermal treatment process, resulting in a film with enhanced graphitic ordering and structural stability.

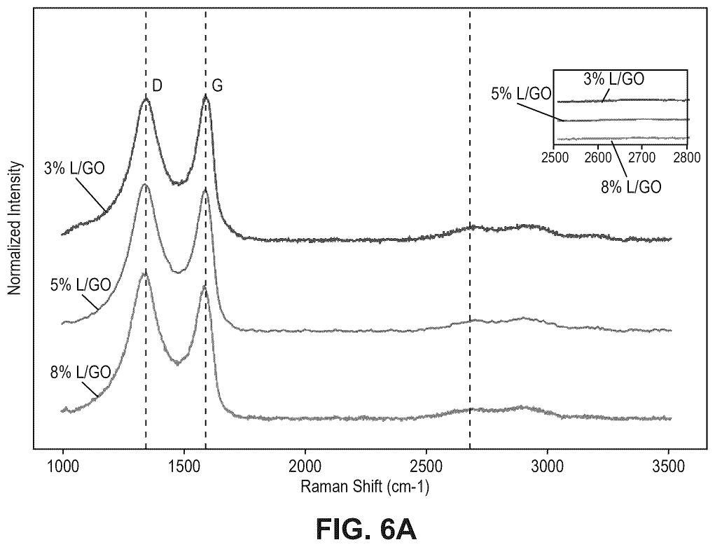

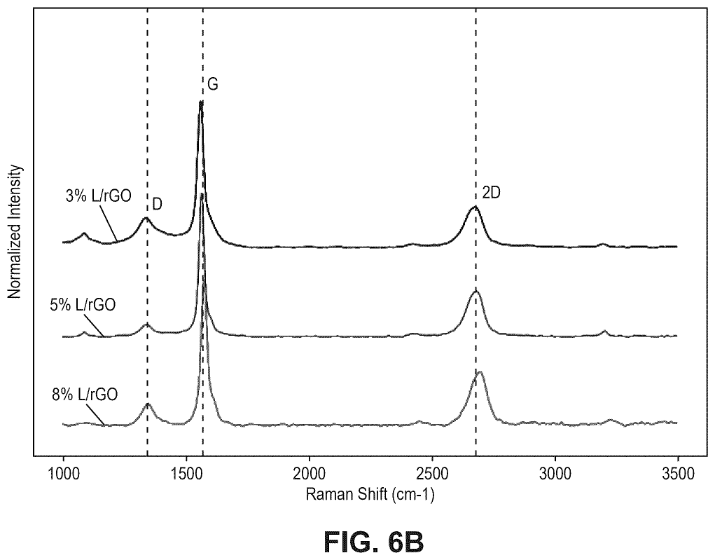

FIG. 6A illustrates Raman spectroscopy analysis of an L/GO film before reduction, having varying amounts of graphene oxide added during the formation process, with the inset showing an enlarged view from 2500 cm⁻¹ to 2800 cm⁻¹, according to some embodiments. FIG. 6B illustrates Raman spectroscopy analysis of an L/rGO film after reduction, having varying amounts of graphene oxide added during the formation process, according to some embodiments.

Raman spectra was used to provide more information about the electronic structure and disorder within L/GO as it transformed into reduced graphene oxide (rGO) during thermal treatment. The spectra revealed significant changes in the material's structure, with key peaks, including the D-band (˜1350 cm⁻¹), the G-band (˜1580 cm⁻¹), and the appearance of the 2D-band (˜2700 cm⁻¹) after reduction.

Before thermal treatment, the Raman spectra of L/GO showed two dominant peaks: the D-band and the G-band. The presence of both the D and G bands is characteristic of graphene oxide, where the oxidation process has introduced defects in the graphene oxide lattice. This result in a high degree of disorder, which is reflected in the intensity of the D-band. The G-band corresponds to the in-plane vibrations of sp²-hybridized carbon atoms, indicating the presence of graphitic domains within the oxidized material. Although the graphene oxide is heavily oxidized, some sp² regions remain intact, contributing to the G-band signal.

Raman spectroscopy was employed to further investigate the electronic structure and disorder within the L/GO composite as it underwent transformation to reduced graphene oxide (rGO) during thermal treatment. The Raman spectra revealed significant structural changes, highlighting peaks such as the D-band (˜1350 cm⁻¹), the G-band (˜1580 cm⁻¹), and the emergence of the 2D-band (˜2700 cm⁻¹) after reduction.

Before thermal treatment, the Raman spectra of the L/GO composite showed two dominant peaks: the D-band and the G-band. The presence of both the D and G bands is characteristic of graphene oxide (GO), where the oxidation process introduces defects into the graphene oxide lattice. This disorder is reflected in the intensity of the D-band, which is associated with sp³ carbon and indicates a high degree of structural defects. The G-band, on the other hand, corresponds to the in-plane vibrations of sp²-hybridized carbon atoms, signifying the presence of graphitic domains within the oxidized material. Although heavily oxidized, some sp² regions remain intact, contributing to the G-band signal and suggesting partial retention of graphitic ordering within the GO.

After thermal treatment, the Raman spectra of the L/rGO composite displays several changes. While the D and G bands remain, the G-band becomes sharper and more pronounced, and the D-band intensity decreases significantly. This shift shows partial restoration of the sp² carbon network as oxygen-containing functional groups are removed, suggesting a reduction in structural defects. Typically, in rGO, the D-band may remain prominent or even increase in intensity due to new defects introduced during the reduction process, such as wrinkling or edge defects. However, in L/rGO, the D-band intensity decreases noticeably, implying a reduction in structural defects rather than their creation. This reduction can be due to the stabilizing role of the layered silicate matrix, which prevents aggregation and restacking of graphene oxide sheets during thermal treatment. By uniformly dispersing graphene oxide sheets, layered silicate allows more effective access for thermal reduction and facilitates the efficient removal of oxygen functionalities. Additionally, the layered silicate matrix helps maintain structural stability during reduction, minimizing the formation of new defects such as wrinkles or edge disruptions, as reflected in the reduced D-band intensity.

One feature in the thermally reduced samples is the emergence of the 2D-band at ˜2700 cm⁻¹, which is either absent or very weak in the initial graphene oxide spectra. The 2D-band is a hallmark of graphene-like materials and is typically associated with stacking order and layer alignment in graphene sheets. Its presence in the L/rGO composite shows the successful reduction of graphene oxide into a more graphitic form with improved layer ordering and alignment.

The 2D/G ratio in the reduced films increases with higher graphene oxide concentration, showing more pronounced 2D-band intensity at higher graphene oxide contents. For example, the 3% L/GO film shows a 2D/G ratio of 0.28, while the 8% graphene oxide film exhibits an increased ratio of 0.37. This increase can results from a stronger Raman signal due to the higher material content rather than a more effective reduction process. In one example, reduction tends to be more effective at lower graphene oxide concentrations, where improved dispersion allows for a more uniform reduction. In another example, at higher graphene oxide concentrations, the tendency of graphene oxide sheets to aggregate may limit the efficiency of the reduction, resulting in a less uniform graphitic structure.

The observed changes in the Raman spectra reflect the structural transformations that occur during thermal reduction. Before reduction, the film is characterized by a high degree of disorder due to oxygenated functional groups, as indicated by the strong D-band. After thermal treatment, while some defects remain, the sharper G-band and the appearance of the 2D-band indicate the formation of rGO with improved graphitic ordering and reduced oxygen content. The stabilizing effect of layered silicate is important in preventing the restacking of rGO layers after reduction, resulting in a more exfoliated and layered structure. This enhanced structure can contribute to improved electrical and mechanical properties in the L/rGO composite.

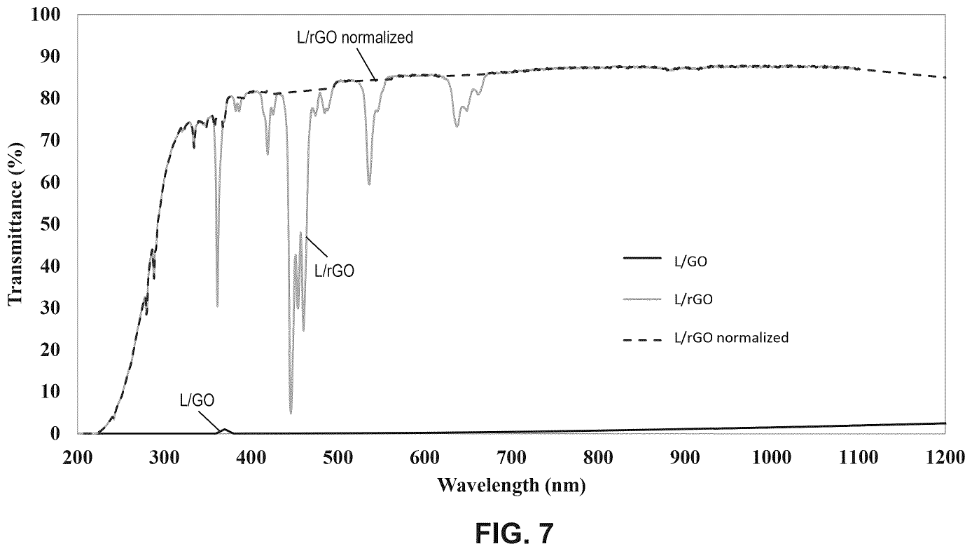

The structural modifications observed by the XRD and Raman directly influenced the optical properties, as captured in UV-Vis transmittance spectroscopy. FIG. 7 illustrates ultraviolet-visible (UV-vis) spectroscopy of L/GO and L/rGO, both formed using a graphene oxide weight percentage of 8 wt. % relative to the total weight of layered silicate, according to some embodiments. To assess the impact of thermal reduction on the optical properties, UV-Vis transmittance spectroscopy was performed on films before and after reduction.

The L/GO film exhibited extremely low transmittance across the entire measured range (200-1200 nm), confirming its strong optical absorption. This behavior is characteristic of graphene oxide (GO), which contains a high density of oxygen functional groups that disrupt the conjugated π-electron system and increase light absorption. The presence of these functional groups introduces localized electronic states, causing strong absorption in both the ultraviolet (UV) and visible regions. As a result, L/GO appears dark and opaque, which can limit its use in applications requiring optical transparency.

Following thermal reduction, the L/rGO film demonstrated a remarkable increase in transmittance, reaching values above 80% in the visible and near-infrared (NIR) regions. This significant enhancement in transparency shows that the thermal treatment effectively removes oxygen-containing functional groups, thereby restoring the extended π-conjugation within the graphene sheets. The reduction process minimizes optical absorption and allows more light to pass through the material, making L/rGO excellent for transparent conductive films. The transmittance spectrum exhibits some fluctuations in the 300-600 nm range, which may be due to interference effects or minor variations in film thickness, which can introduce localized light scattering.

To provide a clearer representation of the optical improvement, the L/rGO normalized transmittance was plotted. This curve highlights the overall trend, showing that L/rGO maintains high transparency (>80%) from ˜400 nm to 1200 nm, demonstrating its excellent potential for optical and electronic applications. The shift from a highly absorptive GO-based composite to a transparent rGO-based film underscores the effectiveness of the layered silicate matrix in preventing excessive aggregation of rGO sheets, thereby maintaining film uniformity and ensuring consistent optical performance.

The ability to achieve high transmittance after thermal reduction can be important for optical and electronic applications, where both conductivity and transparency are desirable. Unlike conventional reduced graphene oxide films, which often retain some degree of light absorption due to aggregation and incomplete reduction, the L/rGO composite achieves superior optical clarity. This improvement can be attributed to the role of layered silicate as a stabilizing agent, which ensures uniform dispersion of graphene oxide prior to reduction and helps maintain structural integrity throughout the process. The findings from UV-Vis spectroscopy show that the L/GO film successfully transitions from a highly absorptive state to a highly transparent material upon thermal reduction.

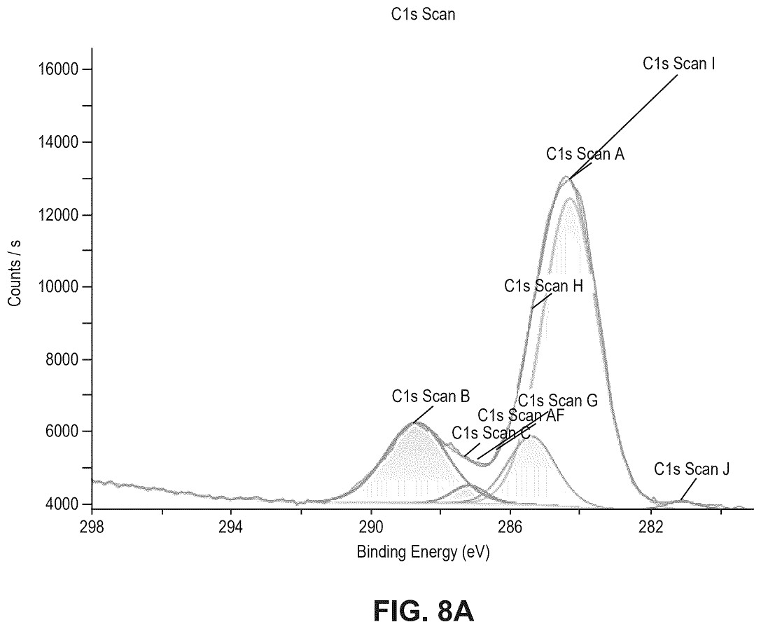

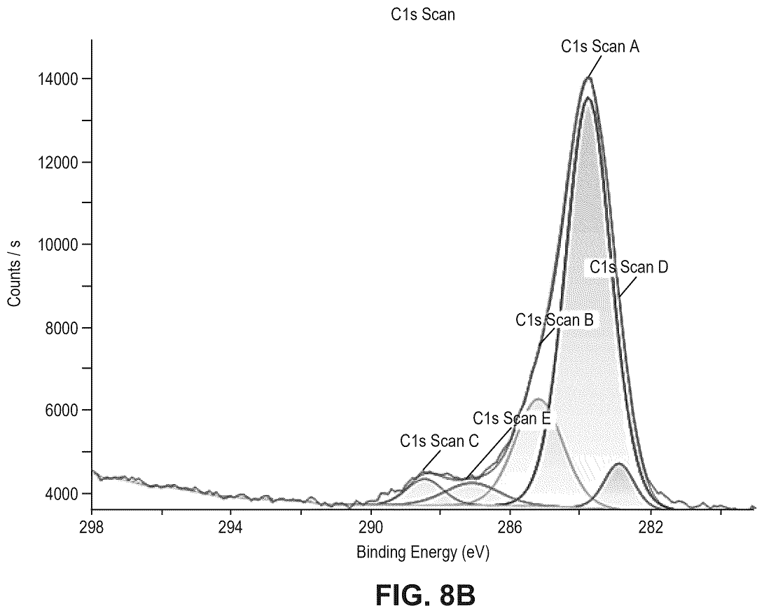

FIG. 8A illustrates X-ray photoelectron spectroscopy (XPS) analysis in the C1s before thermal treatment of an L/GO film, according to some embodiments. FIG. 8B illustrates X-ray photoelectron spectroscopy (XPS) analysis in the C1s after thermal treatment of an L/rGO film, according to some embodiments. Before thermal reduction, the XPS spectrum of the film shows prominent peaks corresponding to oxygen-containing functional groups, including C—O (˜286.5 eV), C═O (˜287.5 eV), and O═C—O (˜289.0 eV), indicative of a highly oxidized graphene oxide structure. The C—C/C═C peak (˜284.5 eV), associated with sp²-hybridized carbon bonds, is present but relatively subdued, reflecting the disruption of the carbon lattice by abundant oxygen functionalities. For example, since the positions of these peaks align with XPS data for graphene oxide, this shows that the layered silicate matrix does not induce any significant shifts in the binding energies of the carbon atoms.

After thermal reduction, the XPS spectrum reveals a substantial decrease in the intensity of the oxygen-related peaks, signifying the removal of oxygen functionalities such as hydroxyl, epoxy, carbonyl, and carboxyl groups. Concurrently, the C—C/C═C peak becomes sharper and more pronounced, showing the restoration of sp² carbon networks and the formation of a more graphitic structure. The positions of the peaks remain consistent with their pre-reduction positions, demonstrating that the layered silicate matrix does not alter the electronic environment of the carbon atoms during the reduction process. Instead, layered silicate plays a stabilizing role, preventing the aggregation and restacking of graphene oxide sheets, which facilitates a more efficient reduction process.

In one example, the absence of peak shifts in the XPS spectra shows that the interaction between layered silicate and GO/rGO is primarily non-covalent or weakly electrostatic, which does not significantly affect the binding energies of the carbon atoms. These findings show that the layered silicate matrix supports the reduction process by stabilizing the graphene oxide structure while allowing the chemical transformation into reduced graphene oxide (rGO). The resulting film exhibits a higher carbon-to-oxygen ratio, reflecting improved graphitic ordering and reduced chemical heterogeneity, which can enhance the material's electrical conductivity.

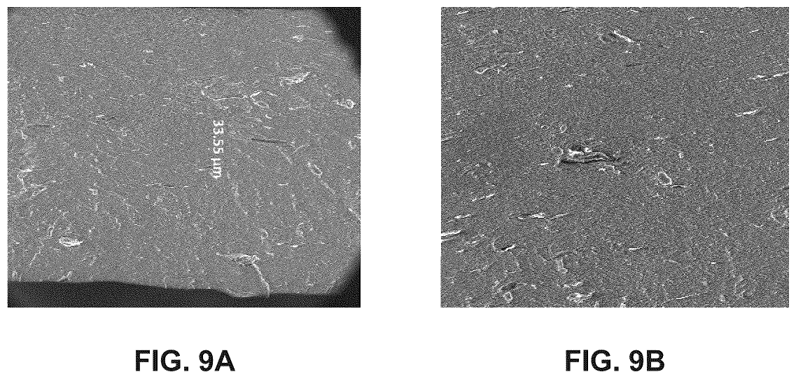

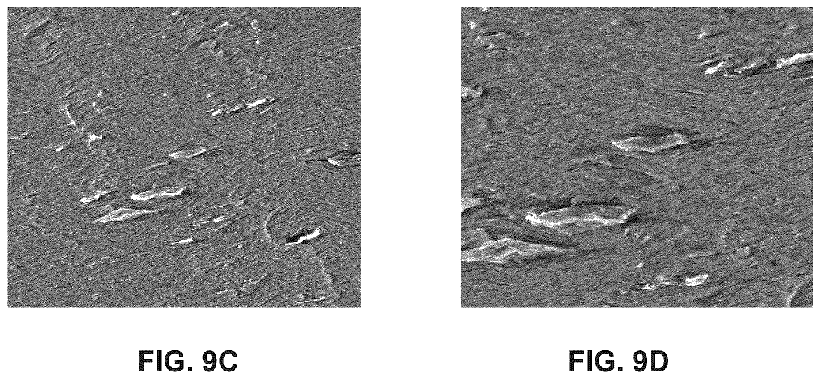

FIG. 9A illustrates a scanning electron microscope (SEM) cross-section image of L/GO film before thermal treatment, according to some embodiments. FIG. 9B illustrates a scanning electron microscope (SEM) cross-section image of L/GO film before thermal treatment, according to some embodiments. FIG. 9C illustrates a scanning electron microscope (SEM) cross-section image of L/GO film before thermal treatment, according to some embodiments. FIG. 9D illustrates a scanning electron microscope (SEM) cross-section image of L/GO film before thermal treatment, according to some embodiments.

Before thermal treatment, SEM cross-sectional images reveal a disordered and loosely packed layered structure with visible surface irregularities and defects. The graphene oxide sheets may appear aggregated in some areas, reflecting incomplete dispersion within the layered silicate matrix. The film thickness is approximately 35.5 μm, with weak interlayer interactions, which can be due to the presence of oxygenated functional groups, as supported by XPS data. These oxygen groups disrupt the stacking order and contribute to the structural heterogeneity observed in SEM, consistent with the findings from XRD and Raman analyses. Complementing this, AFM topography images show significant nanoscale roughness (˜8 nm) and a highly heterogeneous surface. The AFM phase images further reveal large phase shifts, indicating chemical heterogeneity caused by the oxygen functionalities. This heterogeneity is consistent with the disrupted morphology and the highly oxidized state of graphene oxide observed in Raman and XPS analyses.

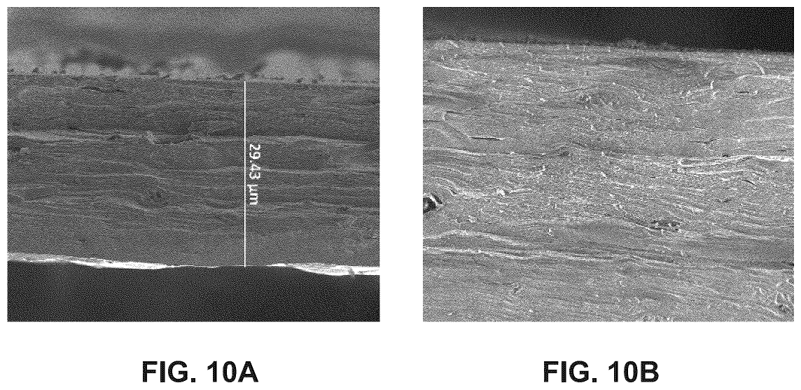

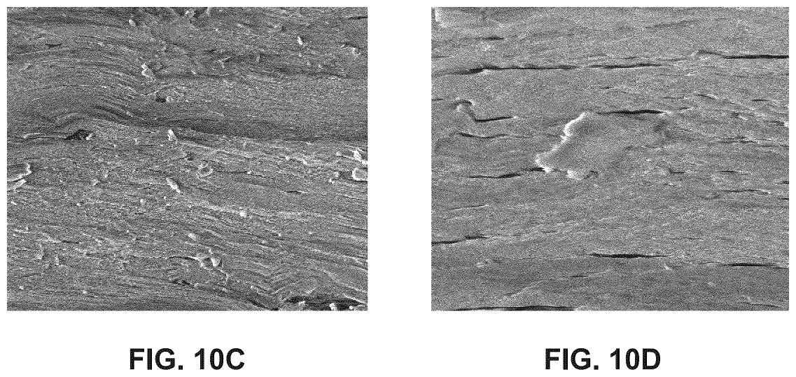

FIG. 10A illustrates a scanning electron microscope (SEM) cross-section image of L/rGO film after thermal treatment, according to some embodiments. FIG. 10B illustrates a scanning electron microscope (SEM) cross-section image of L/rGO film after thermal treatment, according to some embodiments. FIG. 10C illustrates a scanning electron microscope (SEM) cross-section image of L/rGO film after thermal treatment, according to some embodiments. FIG. 10D illustrates a scanning electron microscope (SEM) cross-section image of L/rGO film after thermal treatment, according to some embodiments.

After thermal treatment, both SEM and AFM demonstrate significant improvements in the morphology. The SEM images show a more compact and well-aligned structure, with reduced surface irregularities and a decrease in thickness to approximately 29.3 μm. This compaction correlates with the removal of oxygen functionalities during thermal treatment, as reflected in XRD data showing reduced interlayer spacing and XPS results indicating the restoration of sp² carbon networks. AFM shows these changes at the nanoscale, with a smoother and more homogeneous surface, as indicated by reduced height variations (˜2 nm). The phase images also show lower phase shifts, signifying a reduction in chemical heterogeneity and the uniform distribution of surface properties. The smoother and more compact surface morphology in both SEM and AFM aligns with the Raman findings, where a sharper G-band and diminished D-band intensity indicate the restoration of graphitic order.

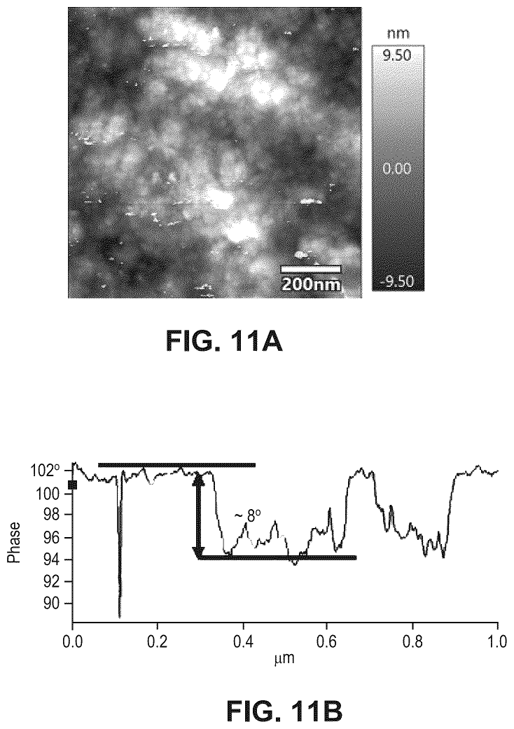

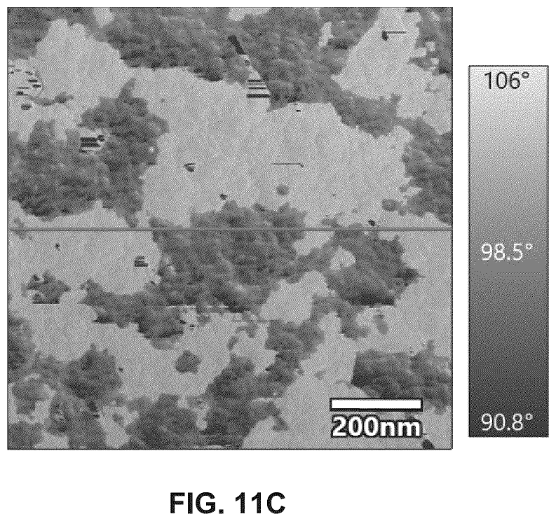

FIG. 11A illustrates atomic force microscopy (AFM) phase imaging of L/GO film before thermal treatment, according to some embodiments. FIG. 11B illustrates atomic force microscopy (AFM) phase imaging results of L/GO film before thermal treatment, according to some embodiments. FIG. 11C illustrates atomic force microscopy (AFM) phase imaging of L/GO film before thermal treatment, according to some embodiments.

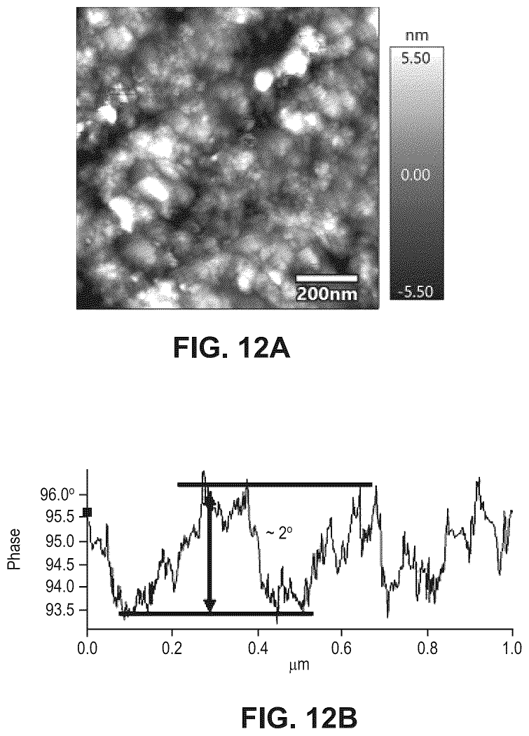

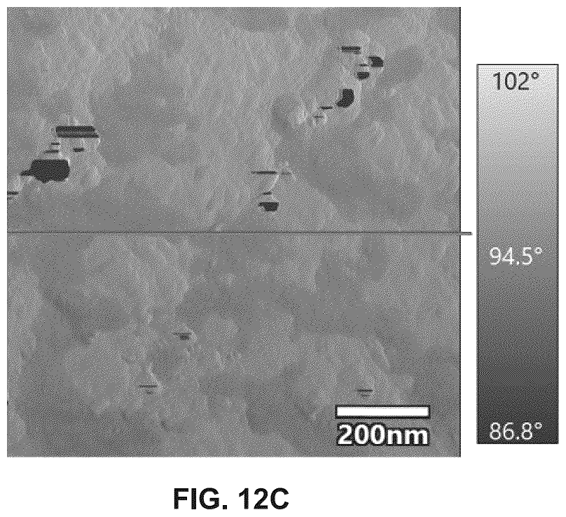

FIG. 12A illustrates atomic force microscopy (AFM) phase imaging of L/rGO film after thermal treatment, according to some embodiments. FIG. 12B illustrates atomic force microscopy (AFM) phase imaging results of L/rGO film after thermal treatment, according to some embodiments. FIG. 12C illustrates atomic force microscopy (AFM) phase imaging of L/rGO film after thermal treatment, according to some embodiments.

Throughout the process, layered silicate plays a role in stabilizing the film. Before reduction, layered silicate prevents excessive stacking of graphene oxide sheets, maintaining a partially exfoliated structure despite the presence of oxygenated groups. After reduction, layered silicate minimizes the restacking of reduced graphene oxide sheets, contributing to a more uniform and compact composite. This stabilizing effect is evident in both SEM and AFM images, which highlight the improved distribution and integration of reduced graphene oxide sheets within the layered silicate matrix.

### Example 4—L/rGO Nanocomposite

The L/GO nanocomposite was synthesized to explore its structural and functional adaptability beyond thin films, particularly in bulk and freeze-dried forms. This composite exhibited distinct textural and morphological properties, with a shift in optical behavior after thermal treatment. Freeze-drying introduced a highly porous architecture, expanding the application of this composite in fields such as thermal insulation and lightweight structural materials.

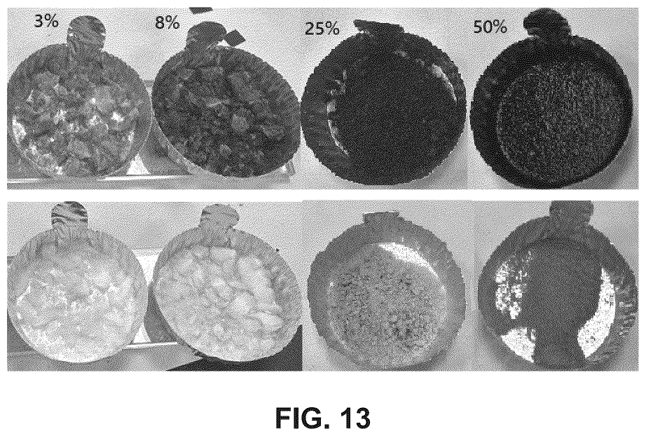

FIG. 13 illustrates composites of the present disclosure before and after thermal treatment, using different concentrations of graphene oxide relative to layered silicate during the formation process, according to some embodiments. The transition from graphene oxide (GO) to reduced graphene oxide (rGO) in the nanocomposite was visually evident from the optical appearance of the material after thermal treatment. Before thermal reduction, the material exhibited a dark, opaque appearance, with the intensity of coloration increasing as the graphene oxide concentration increased from 3% to 50%. At lower graphene oxide concentrations (3% and 8%), the composite maintained a more structured, flaky morphology, while higher graphene oxide concentrations (25% and 50%) resulted in a powder-like and more particulate composite structure.

After thermal treatment, the material underwent a striking transformation, appearing significantly lighter in color, particularly at 3% and 8% GO, where the material displayed a white, highly porous morphology. The samples with 25% and 50% graphene oxide also displayed a lighter appearance but were not as white, indicating that higher graphene oxide content results in a more graphitic, less porous structure upon reduction. This gradient in color and texture shows that the extent of graphene oxide reduction and structural transformation can be highly dependent on the initial graphene oxide concentration. Importantly, a white, porous reduced graphene oxide composite, created via thermal treatment of a freeze-dried layered silicate-GO matrix, was produced.

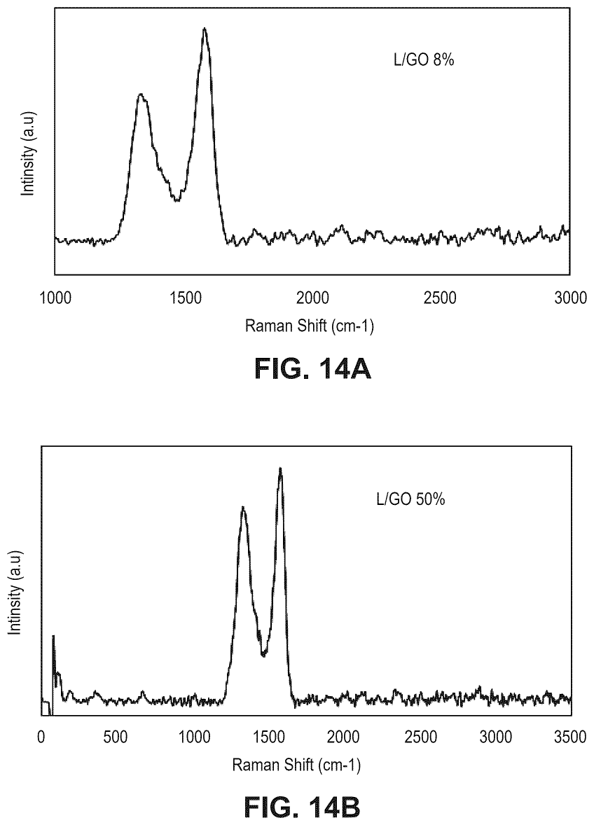

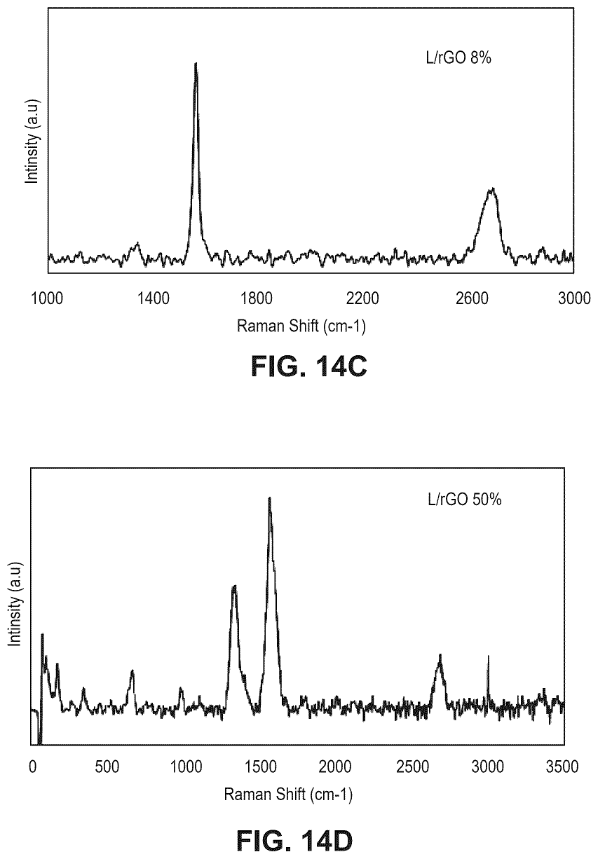

FIG. 14A illustrates a Raman spectrum of an L/GO composite before thermal treatment, according to some embodiments. FIG. 14B illustrates a Raman spectrum of an L/GO composite before thermal treatment, according to some embodiments. FIG. 14C illustrates a Raman spectrum of an L/rGO composite after thermal treatment, according to some embodiments. FIG. 14D illustrates a Raman spectrum of an L/rGO composite after thermal treatment, according to some embodiments.

Raman spectroscopy was used to analyze the structural changes induced by thermal reduction. In the L/GO 8% and L/GO 50% spectra, the characteristic D band (˜1350 cm⁻¹) and G band (˜1580 cm⁻¹) are present, with the D band indicating a high degree of disorder due to oxygen functional groups and structural defects in GO. The intensity of the D band increases with higher graphene oxide concentration (50%), suggesting a greater number of defects and oxygen functionalities.

After thermal reduction, the L/rGO 8% spectrum exhibits a transformation—where the D band is no longer prominent, showing a significant reduction in disorder and defects. The disappearance of the D band shows that the thermal treatment effectively removed a large fraction of the oxygen functionalities and restored the sp² carbon network, leading to a more ordered graphene-like structure. Furthermore, the G band sharpens, indicating improved graphitic ordering, while the emergence of a well-defined 2D band (˜2700 cm⁻¹) shows the formation of multilayer graphene domains.

This reduction in disorder, as evidenced by the loss of the D band, highlights the efficiency of the thermal treatment in producing a more graphitic and structurally refined bulk composite. The absence of the D band shows a significant improvement in the electronic and mechanical properties of the reduced composite, making it more suitable for applications requiring high conductivity and minimal defects.

The D band remains visible but decreases in intensity in L/rGO 50%, indicating a partial reduction of disorder and removal of oxygen functional groups. The persistence of the D band may suggest that some structural defects remain, which can be due to incomplete reduction at higher graphene oxide concentrations. Meanwhile, the G band sharpens, signifying improved graphitic ordering, and the 2D band (˜2700 cm⁻¹) emerges more distinctly, showing the formation of multilayer graphene domains.

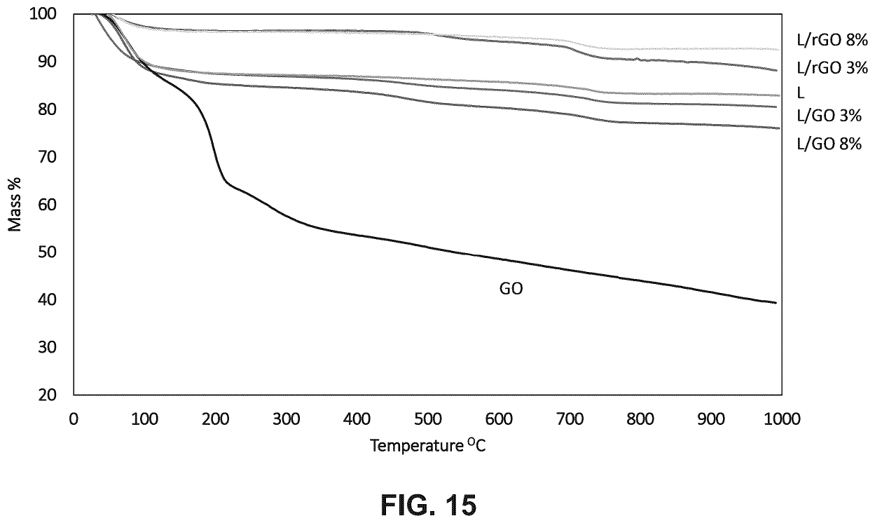

FIG. 15 illustrates thermogravimetric analysis (TGA) of the L/GO composite, L/rGO composites of the present disclosure, pure graphene oxide (GO), and pure layered silicate (L), according to some embodiments. The thermogravimetric analysis (TGA) of the bulk L/GO and reduced L/rGO composites provides insights into their thermal stability and decomposition behavior. Pure graphene oxide (GO) sample exhibits significant weight loss, beginning around 200° C. and continuing up to 600° C., due to the decomposition of oxygen-containing functional groups. This behavior is consistent with the thermal instability of GO, where oxygenated species decompose, releasing CO and CO₂ gases. In contrast, pure layered silicate remains highly stable, with negligible weight loss over the entire temperature range, confirming its resistance to thermal degradation.

The thermal behavior of the L/GO composites demonstrates how the layered silicate contributes to enhancing the stability of GO. In both the L/GO 3% and L/GO 8% samples, the primary weight loss occurs between 100° C. and 300° C., which can be attributed to the removal of moisture and the decomposition of oxygen functional groups within GO. However, compared to pure GO, the rate of mass loss is significantly reduced in the presence of layered silicate. This shows that layered silicate serves as a protective matrix, preventing the rapid degradation of graphene oxide by forming a structural barrier that inhibits direct exposure to heat. The effect is more pronounced in the L/GO 3% sample, where the lower graphene oxide content results in a composite that retains a greater proportion of its initial mass at higher temperatures. In the L/GO 8% composite, the greater graphene oxide content leads to slightly higher weight loss, but the stabilizing influence of layered silicate remains evident.

Following thermal reduction, the L/rGO composites exhibit significantly improved thermal stability. Both the L/rGO 3% and L/rGO 8% samples show a more gradual weight loss compared to their non-reduced counterparts. This enhanced stability shows that the thermal reduction process effectively removes thermally labile oxygen groups, leading to a more graphitic structure with improved resistance to thermal degradation. In particular, the L/rGO 8% sample demonstrates the least weight loss among all GO-containing composites, showing that the higher concentration of reduced graphene oxide contributes to a more stable carbonaceous network.

The L/rGO composites exhibit even greater thermal stability than pure layered silicate (L). While layered silicate alone is highly resistant to decomposition, the reduced graphene network in the L/rGO composites reinforces the overall structural integrity, limiting weight loss at elevated temperatures. This behavior can be attributed to the formation of an interconnected, thermally stable carbon network that strengthens the composite and enhances its ability to withstand heat. The improved stability of the L/rGO samples can be due to strong interfacial interactions between the reduced graphene oxide and layered silicate matrix, which may contribute to better heat resistance and reduced material degradation. Additionally, the removal of volatile oxygen-containing groups during thermal reduction further minimizes mass loss, making the reduced composites even more thermally robust than their L/GO counterparts.

Layered silicate acts as a stabilizing agent that slows down the degradation of GO, while thermal reduction removes thermally labile groups and reinforces the material's structural integrity. The superior thermal stability of the L/rGO composites, particularly when compared to pure layered silicate, highlights the use of these materials for high-temperature applications. This enhanced thermal endurance makes L/rGO composites desirable for applications in thermal coatings, heat-resistant nanocomposites, and energy storage devices where prolonged stability under elevated temperatures is desirable.

Brunauer-Emmett-Teller (BET) was performed. The results show a reduction in surface area following the thermal reduction process. The BET surface area of L/GO-8% is 319.1 m²/g, whereas that of L/rGO-8% is considerably lower at 170.4 m²/g. Graphene oxide (GO) contains a high density of oxygen functionalities that help maintain layer separation by introducing electrostatic repulsion. During thermal reduction, these functional groups are removed, leading to increased van der Waals interactions between graphene sheets, causing partial restacking and subsequently reducing the overall surface area.

TABLE 1
BET Results.

| | BET | Pore | Average |
|---|---|---|---|
| | surface area | volume | pore size |
| Sample | (m²/g) | (cm³/g) | (nm) |
| L/GO-8% | 319.1 | 0.10 | 1.30 nm |
| L/rGO-8% | 170.4 | 0.08 | 1.93 nm |

The pore volume data shows structural densification after reduction. The L/GO-8% sample exhibits a total pore volume of 0.10 cm³/g, whereas the L/rGO-8% sample has a lower pore volume of 0.08 cm³/g. The decrease in pore volume shows that the microporous and mesoporous structures in the composite undergo compaction as graphene oxide transitions to reduced graphene oxide (rGO). This can be due to the collapse of smaller pores, as the removal of oxygen groups enables stronger interlayer interactions that drive the densification of the material. The elimination of functional groups during reduction also results in a less hydrophilic structure, potentially affecting the material's ability to maintain its original porous morphology.

Despite the decline in surface area and pore volume, the average pore size increases from 1.2957 nm in L/GO-8% to 1.9328 nm in L/rGO-8%. This increase shows that while the reduction process eliminates smaller micropores and decreases overall porosity, it simultaneously facilitates the formation of larger pores. The restructuring of the composite material may lead to the consolidation of adjacent pores, forming larger but fewer voids. The increased pore size can be beneficial for applications where transport through the material is desirable, such as in membranes or electrochemical systems. Furthermore, the decreased pore volume shows a denser material structure, which could contribute to improved mechanical stability and enhanced performance in structural or thermal barrier applications.

Overall, these examples highlight the dual impact of thermal reduction on the composite's microstructure: while it reduces available surface area and pore volume due to restacking and densification, it also enhances pore connectivity and increases the average pore size. This balance between structural integrity and porosity can be an important factor for tuning the L/rGO composite for specific technological applications.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A reduced graphene oxide-containing material comprising:
a matrix material including a layered silicate; and
reduced graphene oxide.

2. The reduced graphene oxide-containing material of claim 1, wherein the layered silicate includes a smectite material.

3. The reduced graphene oxide-containing material of claim 2, wherein the smectite material follows a chemical formula: Na^{+0.7}[(Si₈Mg_{5.5}Li_{0.3})O₂₀(OH)₄]^{-0.7}.

4. The reduced graphene oxide-containing material of claim 1, wherein a weight percentage of the reduced graphene oxide ranges from 0.01 wt. % to 15 wt. % of a total weight of the layered silicate in the reduced graphene oxide-containing material.

5. The reduced graphene oxide-containing material of claim 1, wherein a weight percentage of the reduced graphene oxide ranges from 0.01 wt. % to 8 wt. % of a total weight of the layered silicate in the reduced graphene oxide-containing material.

6. The reduced graphene oxide-containing material of claim 1, wherein a weight percentage of the layered silicate in the reduced graphene oxide-containing material is greater than 80 wt. %.

7. The reduced graphene oxide-containing material of claim 6, wherein the reduced graphene oxide-containing material exhibits an average light transmittance value of greater than 70% at 550 nm.

8. The reduced graphene oxide-containing material of claim 1, wherein the reduced graphene oxide-containing material exhibits an average light transmittance value of greater than 80% at 550 nm.

9. The reduced graphene oxide-containing material of claim 1, wherein the reduced graphene oxide-containing material exhibits an average pore size of greater than about 1.5 nm.

10. A method for forming a reduced graphene oxide-containing material comprising:
mixing graphene oxide, a layered silicate, and a solvent to form a mixture;
at least partially removing the solvent from the mixture to form a first material; and
thermally treating the first material to at least partially reduce the graphene oxide and sufficient to form a second material including reduced graphene oxide.

11. The method of claim 10, wherein a weight percentage of graphene oxide in the mixture ranges from 0.01 wt. % to 8 wt. % of a total weight of the layered silicate in the mixture.

12. The method of claim 10, wherein the layered silicate includes a smectite material.

13. The method of claim 10, wherein the solvent includes at least one of water and an organic solvent.

14. The method of claim 10, wherein at least partially removing the solvent includes performing at least one of evaporation or lyophilization.

15. The method of claim 10, wherein thermally treating the first material includes heating the first material at a temperature of greater than about 450° C.

16. The method of claim 15, further including contacting the first material with inert gas, wherein heating the first material at the temperature of greater than about 450° C. is performed for at least 1 hour.

17. A method for forming a reduced graphene oxide-containing material comprising:
mixing graphene oxide, a nanomaterial, and a solvent to form a mixture, wherein the nanomaterial is capable of forming a substantially homogeneous dispersion in water;
freeze-drying the mixture to at least partially remove the solvent and to form a freeze-dried material; and
treating the freeze-dried material to at least partially reduce the graphene oxide and sufficient to form a product material including reduced graphene oxide.

18. The method of claim 17, wherein the nanomaterial includes a layered silicate.

19. The method of claim 18, wherein a weight percentage of graphene oxide in the mixture ranges from 0.01 wt. % to 8 wt. % of a total weight of the layered silicate in the mixture.

20. The method of claim 17, wherein treating the freeze-dried material includes heating the freeze-dried material at a temperature of greater than about 450° C.
